(19) United States
(12) Patent Application Publication
(10) Pub. No.: US 2021/0037470 A1
(43) Pub. Date: Feb. 4, 2021

(54) Wireless Device Grouping Indication Using Wakeup Signal

(71) Applicant: Telefonaktiebolaget LM Ericsson (publ), Stockholm (SE)

(72) Inventors: Magnus Åström, Lund (SE); Johan Bergman, Stockholm (SE); Andreas Höglund, Solna (SE); Yutao Sui, Solna (SE); Anders Wallén, Ystad (SE)

(21) Appl. No.: 16/969,068

(22) PCT Filed: Feb. 18, 2019
(86) PCT No.: PCT/SE2019/050142

§ 371 Date: Aug. 11, 2020

(30) Foreign Application Priority Data
Feb. 16, 2018 (SE) 1800042-2

(51) Int. Cl. H04W 52/02; H04W 68/00; H04W 4/08

(52) U.S. Cl. CPC H04W 52/0229; H04W 4/08; H04W 68/005; H04W 52/0235

(57) ABSTRACT

Apparatuses and methods are disclosed for wireless device (WD) grouping indication using a wake-up signal (WUS). In one embodiment, a method in a WD includes receiving a WUS associated with a paging occasion (PO) of the WD; and based on a grouping indication of the WUS, determining whether the WUS corresponds to at least one WD group that the WD belongs to. In another embodiment, a method in a network node includes configuring a WUS with a grouping indication, the WUS associated with a PO for a wireless device, and the grouping indication indicating at least one WD group that the WD belongs to; and transmitting the WUS according to the grouping indication.

### TECHNICAL FIELD

Wireless communication and in particular, to wireless device (WD) grouping indication using a wake-up signal.

### BACKGROUND

The Third Generation Partnership Project (3GPP) has specified technologies to cover Machine-to-Machine (M2M) and/or Internet of Things (IoT) related use cases. Most recent work for 3GPP Release 13 and 14 proposes enhancements to support Machine-Type Communications (MTC) with new WD categories (Cat-M1, Cat-M2), supporting reduced bandwidth of 6 physical resource blocks (PRBs) (up to 24 PRBs for Cat-M2), and Narrowband IoT (NB-IoT) WDs providing a New Radio (NR) interface (and WD categories, Cat-NB1 and Cat-NB2).

Reference is made to the Long Term Evolution (LTE) enhancements introduced in 3GPP Release 13, 14 and 15 for MTC as “eMTC”, including (not limiting) support for bandwidth limited WDs, Cat-M1, and support for coverage enhancements. This is to separate discussion from NB-IoT (notation used here for any Release), although the supported features are similar on a general level.

There are multiple differences between “legacy” LTE and the procedures and channels defined for eMTC and for NB-IoT. Some differences include a new physical channel, such as the physical downlink control channels (PDCCH), called MPDCCH in eMTC and NPDCCH in NB-IoT, and a new physical random access channel, NPRACH, for NB-IoT. Another difference is the coverage level (also known as coverage enhancement level) that these technologies can support. By applying repetitions to the transmitted signals and channels, both eMTC and NB-IoT allow WD operation down to much lower signal to noise ratio (SNR) level compared to LTE, i.e., Es/Iot≤−15 dB being the lowest operating point for eMTC and NB-IoT, which can be compared to −6 dB Es/IoT for “legacy” LTE.

A paging message typically originates from a source and reaches the receiving network in the mobility management entity (MME). The MME keeps track of the WDs, knowing which cell the WD last resided in. When the WD is to be paged, the MME (first) informs the base station (eNB) of the WD's last known location that there is a paging message for the WD. The eNB then pages the WD at an appropriate occasion.

The WD is informed about the Paging cycle during the initial attach process as part of system information (SIB2). Since the WD knows about the paging cycle and its own paging occasions (POs), during which the WD will momentarily wake up, and check if there is any paging message for itself. In-between the POs, the WD falls back to sleep to preserve power.

Release 15 focuses on reducing WD power consumption even further, by introducing a specific power saving signal. This would allow the WD to skip decoding the relatively large xPDCCH to detect paging and go back to sleep faster.

In Release 15, there is a common work item (WI) objective in the approved work items for both NB-IoT and Rel-15 enhancements for eMTC. The description for NB-IoT is as follows:

Further Latency and Power Consumption Reduction
Power consumption reduction for physical channels
   Study and, if found beneficial, specify for idle mode paging and/or connected mode discontinuous reception (DRX), physical signal/channel that can be efficiently decoded or detected prior to decoding NPDCCH/narrow band physical downlink shared channel (NPDSCH).

And with a similar formulation for eMTC:

Improved Power Consumption:
Power consumption reduction for physical channels
   Study and, if found beneficial for idle mode paging and/or connected mode DRX, specify physical signal/channel that can be efficiently decoded or detected prior to decoding the physical downlink control/data channel.

So far, the topic has been discussed in two RAN1 meetings and most recently in RAN1#89 where it was proposed for both NB-IoT and eMTC that:
A physical signal/channel indicating whether the WD needs to decode subsequent physical channel(s) is introduced, at least for idle mode paging. Candidates for the signal/channel are:
Wake-up signal or discontinuous transmission (DTX):
   Go-to-sleep signal or DTX;
   Wake-up signal with no DTX;
   Downlink control information;
   For further study (FFS) whether synchronization to the camped-on cell is assumed for detecting/decoding wake up signal (WUS)/go to sleep signal (GTS), depending on the (e)DRX cycle length; and
   Design details are FFS; and
   Connected mode DRX is FFS.

The ‘Wake-up signal’ and ‘Go-to-sleep signal’ solutions are based on the transmission of a short signal which would indicate to the WD if it would have to continue to decode the full MPDCCH (eMTC) or NPDCCH (NB-IoT), here jointly referred to as xPDCCH. The decoding time for the former signal is considerably shorter than full MPDCCH or NPDCCH which gives a reduced WD power consumption and longer battery life (this is illustrated in R1-1706887). The ‘Wake-up signal’ (WUS) would be transmitted only when there is paging for the WD; if there is not, the WUS will not be transmitted (the meaning of DTX in the above agreement) and the WD would go back to sleep. The ‘Go-to-sleep signal’ (GTS) would be transmitted only when there is not any paging for the WD; if there is, the GTS will not be transmitted (the meaning of DTX in the above agreement) and the WD would continue to decode NPDCCH or MPDCCH.

In RAN1#90 the following working assumption was proposed:
For idle mode,
   In specifying a power saving physical signal to indicate whether the WD should decode subsequent physical channel(s) for idle mode paging, select a candidate among the following power saving physical signals:
      Wake-up signal or DTX; and
      Wake-up signal with no DTX.

Out of these two remaining options the first will most likely be adopted; however, this may change.

Coverage Enhancement in CIoT Systems

Coverage enhancement in cellular IoT (CIoT) systems are typically performed by repetitions. The deeper coverage, the more repetitions. For deep coverage, up to 2048 repetitions may be used to convey a message. Due to the very low signal-to-noise levels, both channel and noise estimation are highly unreliable. Since it may have been a long time since the WD last connected to the network the network information of the WD is highly unreliable also for that reason. Both the above effects result in very rough estimates of the number of repetitions to use for a specific WD.

Scheduling

Scheduling is the task of fitting as much data into the network as possible. Periodic signals, e.g., broadcast sync signals or master information block (MIB) and system information blocks (SIBs) should share the transmission resources with data and control signals. This problem is further amplified by the many repetitions resulting in long transmissions.

Containing little information, the wake-up signal may provide deep coverage with a very short signal duration and would be relatively easy to schedule if it weren't for its constraint to only be scheduled at certain instants. Conversely, a machine physical downlink shared channel (MPDSCH) signal may contain significantly more data and be targeting a WD with a higher coverage level and may require many more repetitions. Typically, the exact number is only roughly known, e.g., with an accuracy corresponding to a power of two in the number of repetitions.

Paging

As mentioned above, paging is a way for the network to reach the WD. The WD listens to paging in specific occasions, i.e., every DRX or eDRX cycle. If the network needs to reach the WD, the network would send a paging message to the WD.

The WD monitors a common search space, where the network has possibilities to send downlink control information (DCI) scrambled with paging radio network temporary identifier (P-RNTI). If the WD finds a DCI scrambled with P-RNTI, the WD will further check the scheduled PDSCH or NPDSCH to see whether its WD_ID is there. If it finds its WD_ID, it means the WD is paged, and the WD would act accordingly. If the WD does not find its WD_ID, it means this is a false paging, and the WD goes back to idle.

There can be more than one WD IDs carried by one PDSCH/NPDSCH. This gives the network the ability to page several WDs at the same time in order to save network resources. In case of, e.g., system information update, the network can also page all the WDs in a cell at the same time.

WD Subgrouping in WUS

The WUS can be configured to further divide the WDs that monitors the same paging occasion (PO) that can lower the false paging and then save the WD energy, as it reduces the efforts of a WD to monitor the paging message. In this disclosure, this may be referred to as WD subgrouping.

Though WD subgrouping can lower the false paging rate and save the WD energy, there are several problems. First, there are chances that the network pages more than 2 subgroup WDs at the same time, e.g., direct indication. For some proposed solutions, excessive network resources are used in order for the network to reach all the WDs, as all the subgroups need to be paged one by one.

### SUMMARY

Some embodiments advantageously provide methods, wireless devices and network nodes for wireless device (WD) grouping indication using a wake-up signal. Embodiments include a method in a wireless network node that sends a WUS that can page one or multiple WD subgroups that monitor the same paging occasion at the same time. The scheme can achieve energy saving, network resource usage, and paging efficiencies. According to one aspect, a wireless device includes a radio interface module configured to receive a set of symbols and a WD group determination module to identify a WD group based on combined correlation results obtained by correlating each symbol with a sequence.

In accordance with one embodiment, a network node is configured to communicate with a wireless device, WD. The network node is configured to, and/or comprising a radio interface and/or comprising processing circuitry configured to indicate at least one specific wakeup signal, WUS, location to be monitored by WDs in a cell and configure the WUS relative to a paging opportunity with a time offset. In accordance with one aspect of this embodiment the time offset is explicitly signaled to a WD. In accordance with another aspect of this embodiment, the processing circuitry is further configured to designate different WD subgroups to monitor different frequency resources. In accordance with another aspect of this embodiment, the processor is further configured to send the WUS in frequency resources correspond to each subgroup to be paged.

Another embodiment provides a method implemented in a network node, in which the includes indicating at least one specific wakeup signal, WUS, location to be monitored by WDs in a cell and configuring the WUS relative to a paging opportunity with a time offset. In accordance with an aspect of this embodiment, the time offset is explicitly signaled to a WD. In accordance with another aspect of this embodiment, different WD subgroups are designated to monitor different frequency resources. In accordance with another aspect of this embodiment, the WUS in frequency resources correspond to each subgroup to be paged.

Another embodiment provides a wireless device (WD) configured to belong to multiple WD groups at different specific wake up instances, the WD attempting to detect a wake-up signal, WUS, for one of the groups, the WD configured to communicate with a network node, the WD configured to, and/or comprising a radio interface and/or processing circuitry configured to receive a set of symbols, correlate each symbol with a sequence, combine correlation results according to a hypothesis of the multiple WD groups and identify a WD group based on the combined results. In accordance with an aspect of this embodiment, the WD group is identified by a maximum correlation combination. In accordance with another aspect of this embodiment, a WD group is selected only if the identified WD group has a maximum that exceeds a threshold. In accordance with another aspect of this embodiment, the WD determines a time location to performing monitoring of the WUS. In accordance with another aspect of this embodiment, if the identified WD group is for direct indication, the WD performs one of direct system information, SI, update and checking a paging opportunity to determine which SI should be updated.

Another embodiment provides a method in a wireless device (WD) configured to belong to multiple WD groups at different specific wake up instances, the WD attempting to detect a wake-up signal, WUS, for one of the groups, the WD configured to communicate with a network node. The method includes receiving a set of symbols, correlating each symbol with a sequence, combining correlation results according to a hypothesis of the multiple WD groups and identifying a WD group based on the combined results. In accordance with another aspect of this embodiment, the WD group is identified by a maximum correlation combination. In accordance with another aspect of this embodiment, a WD group is selected only if the identified WD group has a maximum that exceeds a threshold. In accordance with another aspect of this embodiment, the method further includes determining a time location to performing monitoring of the WUS. In accordance with another aspect of this embodiment, if the identified WD group is for direct indication, the WD performs one of direct system information, SI, update and checking a paging opportunity to determine which SI should be updated.

Another embodiment provides a network node, comprising a memory module configured to store a wakeup signal, WUS, and a WUS configuration module configured to indicate at least one specific wakeup signal, WUS, location to be monitored by WDs in a cell and configure the WUS relative to a paging opportunity with a time offset.

Another embodiment provides a wireless device, comprising a memory module configured to store correlation results, a radio interface module configured to receive a set of symbols and a WD group determination module configured to correlate each symbol with a sequence, combine correlation results according to a hypothesis of the multiple WD groups and identify a WD group based on the combined results.

According to one aspect of the disclosure, a wireless device, WD, configured to communicate with a network node is provided. The WD comprises a radio interface and processing circuitry configured to receive a wake-up signal, WUS, associated with a paging occasion, PO, of the WD; and based on a grouping indication of the WUS, determine whether the WUS corresponds to at least one WD group that the WD belongs to.

In some embodiments of this aspect, the grouping indication includes at least one of: a cover code of the received WUS, the cover code indicating the at least one WD group; a time location of the received WUS, the time location indicating the at least one WD group; and a frequency resource of the received WUS, the frequency resource indicating the at least one WD group. In some embodiments of this aspect, the grouping indication includes at least one of: a cover code of the received WUS, the cover code indicating the at least one WD group out of multiple WD groups; a time location of the received WUS, the time location indicating the at least one WD group out of multiple WD groups; and a frequency resource of the received WUS, the frequency resource indicating the at least one WD group out of multiple WD groups. In some embodiments of this aspect, the processing circuitry is further configured to: if the grouping indication of the WUS corresponds to a direct indication, at least one of perform a direct system information, SI, update and check the PO to determine which SI to update. In some embodiments of this aspect, the processing circuitry is further configured to: if the grouping indication of the WUS corresponds to the at least one WD group that the WD belongs to, decode a physical downlink channel; and if the grouping indication of the WUS does not correspond to the at least one WD group that the WD belongs to, sleep. In some embodiments of this aspect, the processing circuitry is further configured to determine a time offset relative to the PO to perform monitoring of the WUS. In some embodiments of this aspect, the processing circuitry is further configured to receive the WUS and determine whether the WUS corresponds the at least one WD group that the WD belongs to by being configured to: receive a set of symbols; correlate each symbol with a sequence; combine correlation results; and identify the at least one WD group based at least in part on the combined results.

According to another aspect of the disclosure, a method in a wireless device, WD, is provided. The method comprises receiving a wake-up signal, WUS, associated with a paging occasion, PO, of the WD; and based on a grouping indication of the WUS, determining whether the WUS corresponds to at least one WD group that the WD belongs to.

In some embodiments of this aspect, the grouping indication includes at least one of: a cover code of the received WUS, the cover code indicating the at least one WD group; a time location of the received WUS, the time location indicating the at least one WD group; and a frequency resource of the received WUS, the frequency resource indicating the at least one WD group. In some embodiments of this aspect, the grouping indication includes at least one of: a cover code of the received WUS, the cover code indicating the at least one WD group out of multiple WD groups; a time location of the received WUS, the time location indicating the at least one WD group out of multiple WD groups; and a frequency resource of the received WUS, the frequency resource indicating the at least one WD group out of multiple WD groups. In some embodiments of this aspect, the method further comprises, if the grouping indication of the WUS corresponds to a direct indication, at least one of performing a direct system information, SI, update and checking the PO to determine which SI to update. In some embodiments of this aspect, the method further comprises, if the grouping indication of the WUS corresponds to the at least one WD group that the WD belongs to, decoding a physical downlink channel; and if the grouping indication of the WUS does not correspond to the at least one WD group that the WD belongs to, sleeping. In some embodiments of this aspect, the method further comprises determining a time offset relative to the PO to perform monitoring of the WUS. In some embodiments of this aspect, the receiving the WUS and the determining whether the WUS corresponds the at least one WD group that the WD belongs to by: receiving a set of symbols; correlating each symbol with a sequence; combining correlation results; and identifying the at least one WD group based at least in part on the combined results.

According to yet another aspect of the disclosure, a network node is provided. The network node comprises a radio interface and processing circuitry configured to: configure a wake-up signal, WUS, with a grouping indication, the WUS associated with a paging occasion, PO, for a wireless device, WD, and the grouping indication indicating at least one WD group that the WD belongs to; and transmit the WUS according to the grouping indication.

In some embodiments of this aspect, the grouping indication includes at least one of: a cover code of the transmitted WUS, the cover code indicating the at least one WD group; a time location of the transmitted WUS, the time location indicating the at least one WD group; and a frequency resource of the transmitted WUS, the frequency resource indicating the at least one WD group. In some embodiments of this aspect, the grouping indication includes at least one of: a cover code of the transmitted WUS, the cover code indicating the at least one WD group out of multiple WD groups; a time location of the transmitted WUS, the time location indicating the at least one WD group out of multiple WD groups; and a frequency resource of the transmitted WUS, the frequency resource indicating the at least one WD group out of multiple WD groups. In some embodiments of this aspect, the grouping indication of the WUS corresponds to a direct indication to at least one of perform a direct system information, SI, update and check the PO to determine which SI to update. In some embodiments of this aspect, the processing circuitry is further configured to designate different WD groups to monitor different frequency resources for the WUS. In some embodiments of this aspect, the processing circuitry is further configured to transmit the WUS by being configured to transmit the WUS in frequency resources corresponding to each WD group to be paged. In some embodiments of this aspect, the processing circuitry is further configured to configure the WUS by being configured to configure the WUS relative to the PO with a time offset.

According to another aspect of the disclosure, a method in a network node is provided. The method comprises configuring a wake-up signal, WUS, with a grouping indication, the WUS associated with a paging occasion, PO, for a wireless device, WD, and the grouping indication indicating at least one WD group that the WD belongs to; and transmitting the WUS according to the grouping indication.

In some embodiments of this aspect, the grouping indication includes at least one of: a cover code of the transmitted WUS, the cover code indicating the at least one WD group; a time location of the transmitted WUS, the time location indicating the at least one WD group; and a frequency resource of the transmitted WUS, the frequency resource indicating the at least one WD group. In some embodiments of this aspect, the grouping indication includes at least one of: a cover code of the transmitted WUS, the cover code indicating the at least one WD group out of multiple WD groups; a time location of the transmitted WUS, the time location indicating the at least one WD group out of multiple WD groups; and a frequency resource of the transmitted WUS, the frequency resource indicating the at least one WD group out of multiple WD groups. In some embodiments of this aspect, the grouping indication of the WUS corresponds to a direct indication to at least one of perform a direct system information, SI, update and check the PO to determine which SI to update. In some embodiments of this aspect, the method further includes designating different WD groups to monitor different frequency resources for the WUS. In some embodiments of this aspect, the transmitting the WUS further comprises transmitting the WUS in frequency resources corresponding to each WD group to be paged. In some embodiments of this aspect, the configuring the WUS further comprises configuring the WUS relative to the PO with a time offset.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an exemplary network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a block diagram of an alternative embodiment of a host computer according to some embodiments of the present disclosure;

FIG. 4 is a block diagram of an alternative embodiment of a network node according to some embodiments of the present disclosure;

FIG. 5 is a block diagram of an alternative embodiment of a wireless device according to some embodiments of the present disclosure;

FIG. 6 is a flow chart illustrating exemplary methods implemented in a communication system including a host computer, a network node and a wireless device for executing a client application at a wireless device according to some embodiments of the present disclosure;

FIG. 7 is a flow chart illustrating exemplary methods implemented in a communication system including a host computer, a network node and a wireless device for receiving user data at a wireless device according to some embodiments of the present disclosure;

FIG. 8 is a flow chart illustrating exemplary methods implemented in a communication system including a host computer, a network node and a wireless device for receiving user data from the wireless device at a host computer according to some embodiments of the present disclosure;

FIG. 9 is a flow chart illustrating exemplary methods implemented in a communication system including a host computer, a network node and a wireless device for receiving user data at a host computer according to some embodiments of the present disclosure;

FIG. 10 is a flowchart of an exemplary process in a network node for according to some embodiments of the present disclosure; and

FIG. 11 is a flowchart of an exemplary process in a wireless device according to some embodiments of the present disclosure.

### DETAILED DESCRIPTION

Before describing in detail exemplary embodiments, it is noted that the embodiments reside primarily in combinations of apparatus components and processing steps related to wireless device (WD) grouping indication using a wake-up signal. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (WD) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, integrated access and backhaul (IAB), access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

It should be understood that, in some embodiments, signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g. representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that it represents signaling and/or information for that channel, and/or that the signaling is interpreted by the transmitter and/or receiver to belong to that channel. Such signaling may generally comply with transmission parameters and/or format/s for the channel.

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices, and/or one or more bit patterns representing the information. It may in particular be considered that the RRC signaling as described herein may indicate what subframes or signals to use for one or more of the measurements described herein and under what conditions and/or operational modes.

Configuring a radio node, in particular a terminal or user equipment or the WD, may refer to the radio node being adapted or caused or set and/or instructed to operate according to the configuration. Configuring may be done by another device, e.g., a network node (for example, a radio node of the network like a base station or eNodeB) or network, in which case it may comprise transmitting configuration data to the radio node to be configured. Such configuration data may represent the configuration to be configured and/or comprise one or more instruction pertaining to a configuration, e.g. a configuration for transmitting and/or receiving on allocated resources, in particular frequency resources, or e.g., configuration for performing certain measurements on certain subframes or radio resources. A radio node may configure itself, e.g., based on configuration data received from a network or network node. A network node may use, and/or be adapted to use, its circuitry/ies for configuring. Allocation information may be considered a form of configuration data. Configuration data may comprise and/or be represented by configuration information, and/or one or more corresponding indications and/or message/s.

Generally, configuring may include determining configuration data representing the configuration and providing, e.g. transmitting, it to one or more other nodes (parallel and/or sequentially), which may transmit it further to the radio node (or another node, which may be repeated until it reaches the wireless device). Alternatively, or additionally, configuring a radio node, e.g., by a network node 16 or other device, may include receiving configuration data and/or data pertaining to configuration data, e.g., from another node like a network node 16, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g. WD) may comprise scheduling downlink and/or uplink transmissions for the terminal, e.g. downlink data and/or downlink control signaling and/or DCI and/or uplink control or data or communication signaling, in particular acknowledgement signaling, and/or configuring resources and/or a resource pool therefor. In particular, configuring a terminal (e.g. WD) may comprise configuring the WD to perform certain measurements on certain subframes or radio resources and reporting such measurements according to embodiments of the present disclosure.

As used herein, in some embodiments, the phrase “wake-up signal associated with a paging occasion of the WD” may refer to a wake-up signal (WUS) transmitted and/or received during and/or for a paging occasion of the WD. A paging occasion may be one or more time resources (e.g., slots) for the transmission of paging information to a WD. For example, the WD may be informed about the paging cycle during the initial attach process as part of system information (SIB2). Since the WD knows about the paging cycle and its own paging occasions (POs), during which the WD will momentarily wake up, and check if there is any paging message for itself. In-between the POs, the WD falls back to sleep to preserve power. In some embodiments, the WUS transmitted to/received by the WD e.g., during the WD's PO, may indicate to the WD if the WD should continue to decode the full downlink control channel, or if the WD should go back to sleep.

As used herein, the term “time location” may refer to a time resource (e.g., time slots, symbol(s), subframe, time resource number, time resource index, etc.) or any other type of physical resource or radio resource expressed, at least in part, in terms of length of time.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments include a method in a wireless network node that sends a WUS that can page multiple WD subgroups that monitor the same paging occasion at the same time. The scheme achieves energy saving, network resource usage, and paging efficiencies. According to one aspect, a wireless device includes a radio interface module configured to receive a set of symbols and a WD group determination module to identify a WD group based on combined correlation results obtained by correlating each symbol with a sequence.

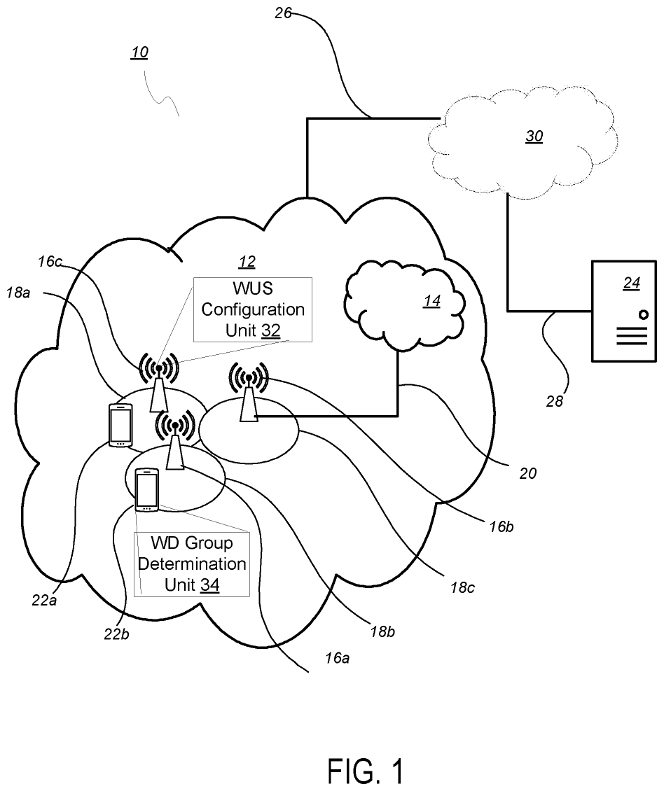

Returning to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16c. A second WD 22b in coverage area 18b is wirelessly connectable to the corresponding network node 16a. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WS 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a WUS configuration unit 32 which is configured to configure a wake-up signal, WUS, with a grouping indication, the WUS associated with a paging occasion, PO, for a wireless device, WD, and the grouping indication indicating at least one WD group that the WD belongs to; and transmit the WUS according to the grouping indication. In another embodiment, the network node 16 includes the WUS configuration unit 32 which is configured to indicate at least one specific wakeup signal, WUS, location to be monitored by WDs in a cell and to configure the WUS relative to a paging opportunity with a time offset. A wireless device 22 is configured to include a WD group determination unit 34 which is configured to receive a wake-up signal, WUS, associated with a paging occasion, PO, of the WD; and based on a grouping indication of the WUS, determine whether the WUS corresponds to at least one WD group that the WD belongs to. In another embodiment, the WD 22 includes the WD group determination unit 34 which is configured to correlate each symbol with a sequence, combine correlation results according to a hypothesis of the multiple WD groups, and identify a WD group based on the combined results.

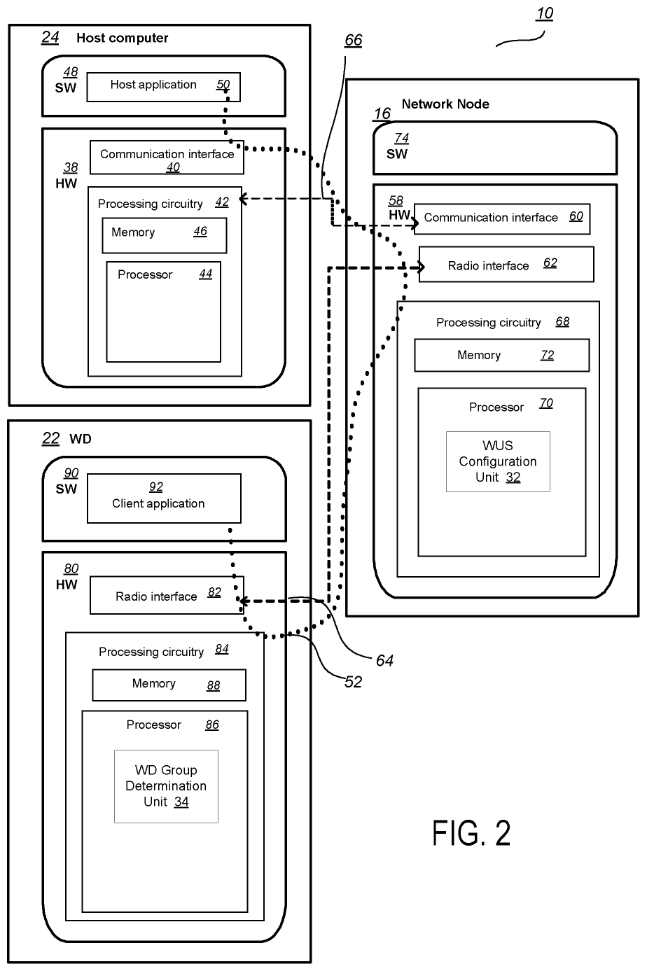

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and comprising hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a WUS configuration unit 32 which is configured to configure a wake-up signal, WUS, with a grouping indication, the WUS associated with a paging occasion, PO, for a wireless device, WD, and the grouping indication indicating at least one WD group that the WD belongs to; and transmit, such as via radio interface 62, the WUS according to the grouping indication.

In some embodiments, the grouping indication includes at least one of: a cover code of the transmitted WUS, the cover code indicating the at least one WD group; a time location of the transmitted WUS, the time location indicating the at least one WD group; and a frequency resource of the transmitted WUS, the frequency resource indicating the at least one WD group. In some embodiments, the grouping indication includes at least one of: a cover code of the transmitted WUS, the cover code indicating the at least one WD group out of multiple WD groups; a time location of the transmitted WUS, the time location indicating the at least one WD group out of multiple WD groups; and a frequency resource of the transmitted WUS, the frequency resource indicating the at least one WD group out of multiple WD groups. In some embodiments, the grouping indication of the WUS corresponds to a direct indication to at least one of perform a direct system information, SI, update and check the PO to determine which SI to update. In some embodiments, the processing circuitry 68 is further configured to designate different WD groups to monitor different frequency resources for the WUS. In some embodiments, the processing circuitry 68 is further configured to transmit, such as via radio interface 62, the WUS by being configured to transmit the WUS in frequency resources corresponding to each WD group to be paged. In some embodiments, the processing circuitry 68 is further configured to configure the WUS by being configured to configure the WUS relative to the PO with a time offset.

In another embodiment, processing circuitry 68 of the network node 16 may include a WUS configuration unit 32 which is configured to indicate at least one specific wakeup signal, WUS, location to be monitored by WDs in a cell and to configure the WUS relative to a paging opportunity with a time offset.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD group determination unit 34 which is configured to receive a wake-up signal, WUS, associated with a paging occasion, PO, of the WD; and based on a grouping indication of the WUS, determine whether the WUS corresponds to at least one WD group that the WD belongs to.

In some embodiments, the grouping indication includes at least one of: a cover code of the received WUS, the cover code indicating the at least one WD group; a time location of the received WUS, the time location indicating the at least one WD group; and a frequency resource of the received WUS, the frequency resource indicating the at least one WD group. In some embodiments, the grouping indication includes at least one of: a cover code of the received WUS, the cover code indicating the at least one WD group out of multiple WD groups; a time location of the received WUS, the time location indicating the at least one WD group out of multiple WD groups; and a frequency resource of the received WUS, the frequency resource indicating the at least one WD group out of multiple WD groups. In some embodiments, the processing circuitry 84 is further configured to, if the grouping indication of the WUS corresponds to a direct indication, at least one of perform a direct system information, SI, update and check the PO to determine which SI to update. In some embodiments, the processing circuitry 84 is further configured to: if the grouping indication of the WUS corresponds to the at least one WD group that the WD belongs to, decode a physical downlink channel; and if the grouping indication of the WUS does not correspond to the at least one WD group that the WD belongs to, sleep. In some embodiments, the processing circuitry 84 is further configured to determine a time offset relative to the PO to perform monitoring of the WUS. In some embodiments, the processing circuitry 84 is further configured to receive the WUS and determine whether the WUS corresponds the at least one WD group that the WD belongs to by being configured to: receive a set of symbols; correlate each symbol with a sequence; combine correlation results; and identify the at least one WD group based at least in part on the combined results.

In another embodiment, the wireless device 22 may include a WD group determination unit 34 which is configured to correlate each symbol with a sequence, combine correlation results according to a hypothesis of the multiple WD groups, and identify a WD group based on the combined results.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as WUS configuration unit 32, and WD group determination unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

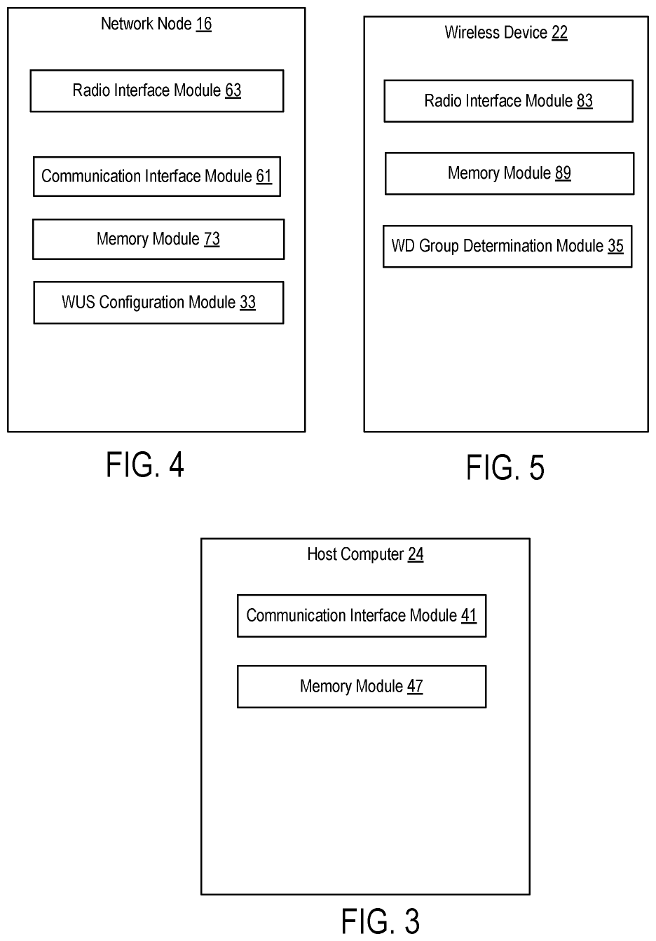

FIG. 3 is a block diagram of an alternative host computer 24, which may be implemented at least in part by software modules containing software executable by a processor to perform the functions described herein. The host computer 24 include a communication interface module 41 configured to set up and maintain a wired or wireless connection with an interface of a different communication device of the communication system 10. The memory module 47 is configured to store data, programmatic software code and/or other information described herein.

FIG. 4 is a block diagram of an alternative network node 16, which may be implemented at least in part by software modules containing software executable by a processor to perform the functions described herein. The network node 16 includes a radio interface module 63 configured for setting up and maintaining at least a wireless connection 64 with a WD 22 located in a coverage area 18 served by the network node 16. The network node 16 also includes a communication interface module 61 configured for setting up and maintaining a wired or wireless connection with an interface of a different communication device of the communication system 10. The communication interface module 61 may also be configured to facilitate a connection 66 to the host computer 24. The memory module 73 that is configured to store data, programmatic software code and/or other information described herein. The WUS configuration module 33 which is configured to indicate at least one specific wakeup signal, WUS, location to be monitored by WDs in a cell and to configure the WUS relative to a paging opportunity with a time offset.

FIG. 5 is a block diagram of an alternative wireless device 22, which may be implemented at least in part by software modules containing software executable by a processor to perform the functions described herein. The WD 22 includes a radio interface module 83 configured to set up and maintain a wireless connection 64 with a network node 16 serving a coverage area 18 in which the WD 22 is currently located. The memory module 89 is configured to store data, programmatic software code and/or other information described herein. The WD group determination module 35 which is configured to correlate each symbol with a sequence, combine correlation results according to a hypothesis of the multiple WD groups, and identify a WD group based on the combined results.

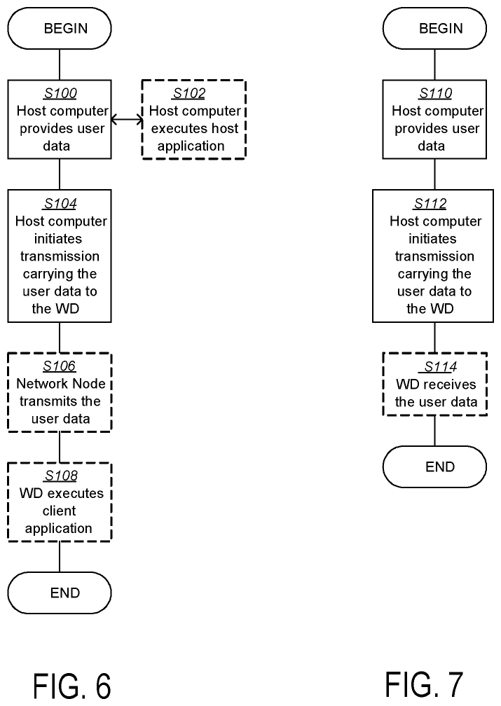

FIG. 6 is a flowchart illustrating an exemplary method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (block S100). In an optional substep of the first step, the host computer 24 provides the user data by executing a host application, such as, for example, the host application 74 (block S102). In a second step, the host computer 24 initiates a transmission carrying the user data to the WD 22 (block S104). In an optional third step, the network node 16 transmits to the WD 22 the user data which was carried in the transmission that the host computer 24 initiated, in accordance with the teachings of the embodiments described throughout this disclosure (block S106). In an optional fourth step, the WD 22 executes a client application, such as, for example, the client application 114, associated with the host application 74 executed by the host computer 24 (block S108).

FIG. 7 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (block S110). In an optional substep (not shown) the host computer 24 provides the user data by executing a host application, such as, for example, the host application 74. In a second step, the host computer 24 initiates a transmission carrying the user data to the WD 22 (block S112). The transmission may pass via the network node 16, in accordance with the teachings of the embodiments described throughout this disclosure. In an optional third step, the WD 22 receives the user data carried in the transmission (block S114).

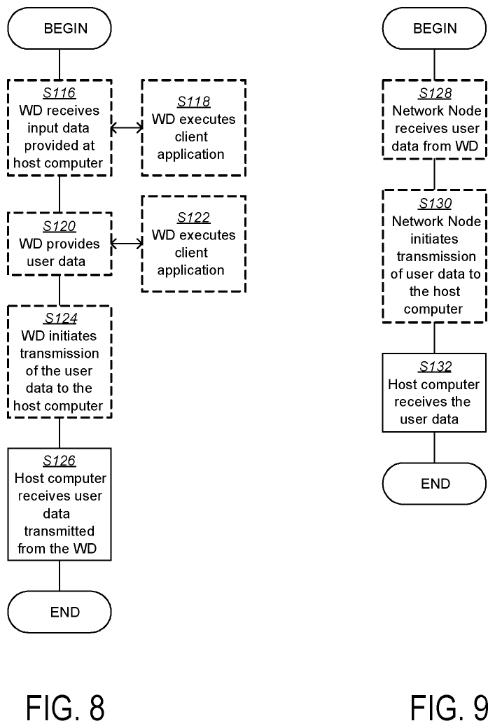

FIG. 8 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (block S116). In an optional substep of the first step, the WD 22 executes the client application 114, which provides the user data in reaction to the received input data provided by the host computer 24 (block S118). Additionally or alternatively, in an optional second step, the WD 22 provides user data (block S120). In an optional substep of the second step, the WD provides the user data by executing a client application, such as, for example, client application 114 (block S122). In providing the user data, the executed client application 114 may further consider user input received from the user. Regardless of the specific manner in which the user data was provided, the WD 22 may initiate, in an optional third substep, transmission of the user data to the host computer 24 (block S124). In a fourth step of the method, the host computer 24 receives the user data transmitted from the WD 22, in accordance with the teachings of the embodiments described throughout this disclosure (block S126).

FIG. 9 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (block S128). In an optional second step, the network node 16 initiates transmission of the received user data to the host computer 24 (block S130). In a third step, the host computer 24 receives the user data carried in the transmission initiated by the network node 16 (block S132).

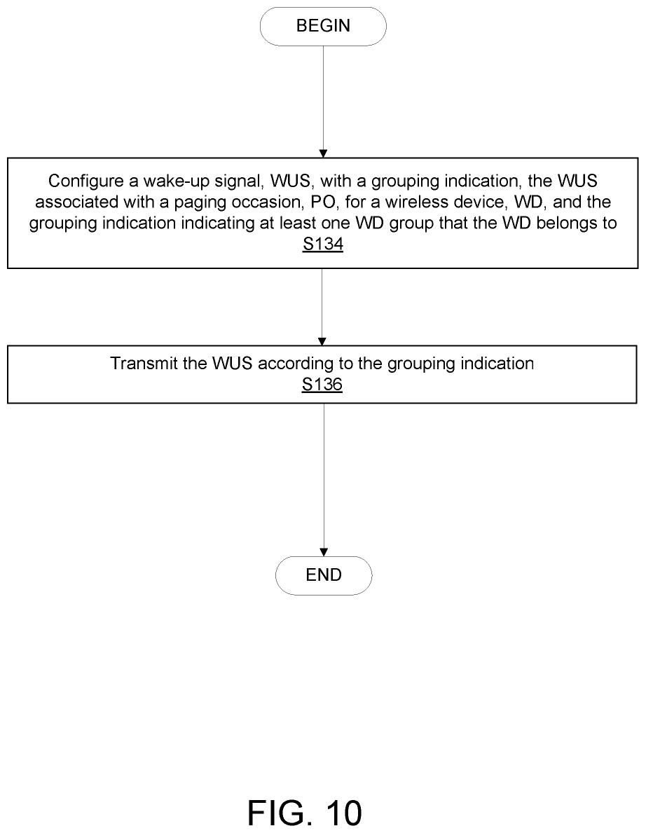

FIG. 10 is a flowchart of an exemplary process in a network node 16 to identify a WUS for monitoring by a WD 22 according to principles set forth herein. In one embodiment, the process includes configuring (block S136), such as via processing circuitry 68 and/or WUS configuration unit 32, a wake-up signal, WUS, with a grouping indication, the WUS associated with a paging occasion, PO, for a wireless device, WD, and the grouping indication indicating at least one WD group that the WD belongs to. The process includes transmitting (block S138), such as via radio interface 62, the WUS according to the grouping indication.

In some embodiments, the grouping indication includes at least one of: a cover code of the transmitted WUS, the cover code indicating the at least one WD group; a time location of the transmitted WUS, the time location indicating the at least one WD group; and a frequency resource of the transmitted WUS, the frequency resource indicating the at least one WD group. In some embodiments, the grouping indication includes at least one of: a cover code of the transmitted WUS, the cover code indicating the at least one WD group out of multiple WD groups; a time location of the transmitted WUS, the time location indicating the at least one WD group out of multiple WD groups; and a frequency resource of the transmitted WUS, the frequency resource indicating the at least one WD group out of multiple WD groups. In some embodiments, the grouping indication of the WUS corresponds to a direct indication to at least one of perform a direct system information, SI, update and check the PO to determine which SI to update. In some embodiments, the method further includes designating, such as via processing circuitry 68 and/or WUS configuration unit 32, different WD groups to monitor different frequency resources for the WUS. In so me embodiments, the transmitting, such as via radio interface 62, the WUS further comprises transmitting the WUS in frequency resources corresponding to each WD 22 group to be paged. In some embodiments, the configuring, such as via processing circuitry 68 and/or WUS configuration unit 32, the WUS further comprises configuring the WUS relative to the PO with a time offset.

In another embodiment, the process includes indicating, via a WUS configuration module 33, at least one specific wakeup signal, WUS, location to be monitored by WDs in a cell. The process also includes configuring, via the WUS configuration module 33, the WUS relative to a paging opportunity with a time offset.

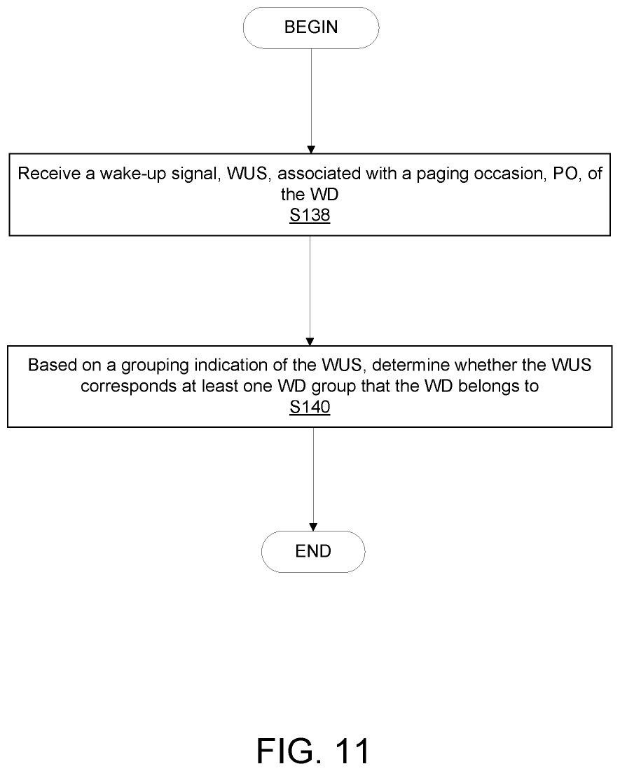

FIG. 11 is a flowchart of an exemplary process in a wireless device 22 according to some embodiments of the present disclosure. The process includes receiving (block S138), such as via processing circuitry 84 and/or WD group determination unit 34, a wake-up signal, WUS, associated with a paging occasion, PO, of the WD. The process includes, based on a grouping indication of the WUS, determining (block S140), such as via processing circuitry 84 and/or WD group determination unit 34, whether the WUS corresponds to at least one WD group that the WD belongs to.

In some embodiments, the grouping indication includes at least one of: a cover code of the received WUS, the cover code indicating the at least one WD group; a time location of the received WUS, the time location indicating the at least one WD group; and a frequency resource of the received WUS, the frequency resource indicating the at least one WD group. In some embodiments, the grouping indication includes at least one of: a cover code of the received WUS, the cover code indicating the at least one WD group out of multiple WD groups; a time location of the received WUS, the time location indicating the at least one WD group out of multiple WD groups; and a frequency resource of the received WUS, the frequency resource indicating the at least one WD group out of multiple WD groups. In some embodiments, the method further includes, if the grouping indication of the WUS corresponds to a direct indication, at least one of performing a direct system information, SI, update and checking the PO to determine which SI to update. In some embodiments, the method further includes, if the grouping indication of the WUS corresponds to the at least one WD group that the WD belongs to, decoding a physical downlink channel; and if the grouping indication of the WUS does not correspond to the at least one WD group that the WD belongs to, sleeping. In some embodiments, the method further includes determining, such as via processing circuitry 84 and/or WD group determination unit 34, a time offset relative to the PO to perform monitoring of the WUS. In some embodiments, the receiving the WUS and the determining whether the WUS corresponds the at least one WD group that the WD belongs to by: receiving, such as via radio interface 82, a set of symbols; correlating each symbol with a sequence; combining correlation results; and identifying, such as via processing circuitry 84 and/or WD group determination unit 34, the at least one WD group based at least in part on the combined results.

In another embodiment, the process includes receiving, via a radio interface module 83, a set of symbols. The process also includes correlating, via the WD group determination module 35, correlating each symbol with a sequence. The process also includes combining, via the WD group determination module 35, correlation results according to a hypothesis of the multiple WD groups and identifying a WD group based on the combined results.

Some example embodiments are set forth as follows.

Solution 1: Cover Code Based Solution

In this first solution, a cover code may be used to distinguish different subgroup of WDs 22. In addition, cover codes may be designed that correspond to more than one subgroup. For example, a WD 22 would be able to decode multiple groups with a single correlation operation, by performing post correlation combining and hypothesis testing. Hence, the complexity for such dual group belongings is negligible. It should also be noted that, although a slight increase in the false detection rate can be expected, that is outweighed by the fewer false detections from the smaller WD set, and the missed detection rate remains unchanged. A reason for that is that the WD 22 typically does not attempt to determine the most likely transmitted code in the code set, but only whether the WD's allocated code was transmitted.

In one embodiment, a WD 22 can be assigned (e.g., by the network node 16) to more than one subgroup in one WUS location that corresponds to the PO it needs to monitor for paging. The WD 22 monitors the WUS based on different code sequences according to the subgroups to which the WD 22 is assigned.

In one embodiment, there is a WUS sequence that can indicate all the WD 22 subgroups that monitor the same PO. In some embodiments, the WD 22 may be required to monitor this sequence, as well as the WUS sequence corresponding to its own WD 22 subgroup.

Solution 2: Time Based Solution

In this solution, different time locations of the WUS are used to indicate whether all the WDs are paged or only the WD 22 subgroup is paged.

In one embodiment, a network (e.g., network node 16) can indicate that there is one or more specific WUS locations that all WDs in a cell should monitor, e.g., for direct indication of system information change. If the WD 22 identifies this WUS, the WD 22 either monitors its own PO for paging message, for example, to see which system information (SI) is updated, or directly perform system information update.

In one embodiment, a WD 22 may monitor at least two WUS locations, one for paging of the subgroup it is assigned to and one for paging for the purpose of direct indication.

In one embodiment, the network (e.g., network node 16) can assign a WD 22 to more than one subgroup, and the WD 22 monitors the WUS for the subgroups it belongs to at different time locations.

Solution 2: Frequency Based Solution

In this solution, different frequency resources are used at the same time location to indicate how the WD 22 is paged.

In some embodiments, the network (e.g., network node 16) configures the WUS relative to the corresponding PO with a time offset. The time offset can be either explicitly signaled to the WD 22 or implicitly derived by the WD 22. In the WUS location, the network (e.g., network node 16) can indicate different WD 22 subgroups to monitor different frequency resources. In this way, if more than one subgroup of WDs 22 are paged, the network (e.g., network node 16) simply sends the WUS in the frequency resources corresponding to these subgroups of WDs 22. If all WDs 22 in the system are to be paged, then the network (e.g., network node 16) simply sends the WUS in all the frequency resources.

It is also possible to combine any and/or all the solutions mentioned above in any manner.

Some other embodiments include the following.

For cover code based solutions:
A WD 22 configured to belong to multiple WD 22 groups at a specific wake-up instant, attempting to detect a WUS for one of the groups, the method comprises
a) Receiving a set of symbols
b) Correlating each symbol with a sequence
c) Combining the correlates according to the hypotheses of the different groups
d) Identifying the correct WD 22 group based on the correlate combinations.
In some embodiments, the correct WD 22 group is the maximum correlate combination
In some embodiments, only if the identified group has a maximum exceeding a threshold is it determined

For time based solution:
A WD 22 configured to belong to multiple WD 22 groups at different specific wake-up instant, attempting to detect a WUS for one of the groups, the method comprises:
a) Determine which time location to monitor
b) Receiving a set of symbols
c) Correlating each symbol with a sequence
d) Identifying the correct WD 22 group based on the correlate combinations.
In some embodiments, the correct WD 22 group is the maximum correlate combination
In some embodiments, only if the identified group has a maximum exceeding a threshold is it determined
In some embodiments, if the identified group is for direct indication, the WD 22 either performs SI update directly, or check its PO to find out which SI should be updated.

For frequency based solutions:
The network configures the WD 22 at a specific wake-up instant, and the WD 22 attempting to detect a WUS for one of the groups, the method comprises
a) Receiving a set of symbols at the configured frequency
b) Correlating each symbol with a sequence
c) Identifying the correct WD 22 group based on the correlate combinations.
In some embodiments, only if the identified group has a maximum exceeding a threshold is it determined.

Accordingly, techniques for wireless device (WD) grouping indication using a wake-up signal have been described.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1-28. (canceled)

29. A wireless device (WD) configured to communicate with a network node, the WD comprising a radio interface and processing circuitry configured to:
receive a wake-up signal (WUS) associated with a paging occasion of the WD; and
based on a grouping indication of the WUS, determine whether the WUS corresponds to at least one WD group that the WD belongs to.

30. The WD of claim 29, wherein the grouping indication includes:
a cover code of the received WUS, the cover code indicating the at least one WD group;
a time location of the received WUS, the time location indicating the at least one WD group; and/or
a frequency resource of the received WUS, the frequency resource indicating the at least one WD group.

31. The WD of claim 29, wherein the grouping indication includes:
a cover code of the received WUS, the cover code indicating the at least one WD group out of multiple WD groups;
a time location of the received WUS, the time location indicating the at least one WD group out of multiple WD groups; and/or
a frequency resource of the received WUS, the frequency resource indicating the at least one WD group out of multiple WD groups.

32. The WD of claim 29, wherein the processing circuitry is configured to perform, if the grouping indication of the WUS corresponds to a direct indication, a direct system information (SI) update and/or check the paging occasion to determine which SI to update.

33. The WD of claim 29, wherein the processing circuitry is configured to:
decode, if the grouping indication of the WUS corresponds to the at least one WD group that the WD belongs to, a physical downlink channel; and
sleep if the grouping indication of the WUS does not correspond to the at least one WD group that the WD belongs to.

34. The WD of claim 29, wherein the processing circuitry is configured to determine a time offset relative to the paging occasion to perform monitoring of the WUS.

35. The WD of claim 29, wherein the processing circuitry is configured to determine whether the WUS corresponds the at least one WD group that the WD belongs to by being configured to:
receive a set of symbols;
correlate each symbol with a sequence;
combine correlation results; and
identify the at least one WD group based at least in part on the combined results.

36. A method in a wireless device (WD), the method comprising:
receiving a wake-up signal (WUS) associated with a paging occasion of the WD; and
determining, based on a grouping indication of the WUS, whether the WUS corresponds to at least one WD group that the WD belongs to.

37. The method of claim 36, wherein the grouping indication includes:
a cover code of the received WUS, the cover code indicating the at least one WD group;
a time location of the received WUS, the time location indicating the at least one WD group; and/or
a frequency resource of the received WUS, the frequency resource indicating the at least one WD group.

38. The method of claim 36, wherein the grouping indication includes:
a cover code of the received WUS, the cover code indicating the at least one WD group out of multiple WD groups;
a time location of the received WUS, the time location indicating the at least one WD group out of multiple WD groups; and/or
a frequency resource of the received WUS, the frequency resource indicating the at least one WD group out of multiple WD groups.

39. The method of claim 36, further comprising performing, if the grouping indication of the WUS corresponds to a direct indication, a direct system information (SI) update and/or checking the paging occasion to determine which SI to update.

40. The method of claim 36, further comprising:
decoding, if the grouping indication of the WUS corresponds to the at least one WD group that the WD belongs to, a physical downlink channel; and
sleeping if the grouping indication of the WUS does not correspond to the at least one WD group that the WD belongs to.

41. The method of claim 36, further comprising determining a time offset relative to the paging occasion to perform monitoring of the WUS.

42. The method of claim 36, wherein the receiving the WUS and the determining whether the WUS corresponds the at least one WD group that the WD belongs to comprises:
receiving a set of symbols;
correlating each symbol with a sequence;
combining correlation results; and
identifying the at least one WD group based at least in part on the combined results.

43. A network node comprising a radio interface and processing circuitry configured to:
configure a wake-up signal (WUS) with a grouping indication, the WUS associated with a paging occasion for a wireless device (WD), wherein the grouping indication indicates at least one WD group that the WD belongs to; and
transmit the WUS according to the grouping indication.

44. The network node of claim 43, wherein the grouping indication includes:
a cover code of the transmitted WUS, the cover code indicating the at least one WD group;
a time location of the transmitted WUS, the time location indicating the at least one WD group; and/or
a frequency resource of the transmitted WUS, the frequency resource indicating the at least one WD group.

45. The network node of claim 43, wherein the grouping indication includes:
a cover code of the transmitted WUS, the cover code indicating the at least one WD group out of multiple WD groups;
a time location of the transmitted WUS, the time location indicating the at least one WD group out of multiple WD groups; and/or
a frequency resource of the transmitted WUS, the frequency resource indicating the at least one WD group out of multiple WD groups.

46. The network node of claim 43, wherein the grouping indication of the WUS corresponds to a direct indication to perform a direct system information (SI) update and/or check the paging occasion to determine which SI to update.

47. The network node of claim 43, wherein the processing circuitry is configured to designate different WD groups to monitor different frequency resources for the WUS.

48. The network node of claim 43, wherein the processing circuitry is configured to transmit the WUS by transmitting the WUS in frequency resources corresponding to each WD group to be paged.

49. The network node of claim 43, wherein the processing circuitry is configured to configure the WUS by configuring the WUS relative to the paging occasion with a time offset.

50. A method in a network node, the method comprising:
configuring a wake-up signal (WUS) with a grouping indication, the WUS associated with a paging occasion for a wireless device (WD), wherein the grouping indication indicates at least one WD group that the WD belongs to; and
transmitting the WUS according to the grouping indication.

51. The method of claim 50, wherein the grouping indication includes:
a cover code of the transmitted WUS, the cover code indicating the at least one WD group;
a time location of the transmitted WUS, the time location indicating the at least one WD group; and/or
a frequency resource of the transmitted WUS, the frequency resource indicating the at least one WD group.

52. The method of claim 50, wherein the grouping indication includes:
a cover code of the transmitted WUS, the cover code indicating the at least one WD group out of multiple WD groups;
a time location of the transmitted WUS, the time location indicating the at least one WD group out of multiple WD groups; and/or
a frequency resource of the transmitted WUS, the frequency resource indicating the at least one WD group out of multiple WD groups.

53. The method of claim 50, wherein the grouping indication of the WUS corresponds to a direct indication to perform a direct system information (SI) update and/or check the paging occasion to determine which SI to update.

54. The method of claim 50, further comprising designating different WD groups to monitor different frequency resources for the WUS.

55. The method of claim 50, wherein the transmitting the WUS comprises transmitting the WUS in frequency resources corresponding to each WD group to be paged.

56. The method of claim 50, wherein the configuring the WUS comprises configuring the WUS relative to the paging occasion with a time offset.
